(19) United States
(12) Patent Application Publication
(10) Pub. No.: US 2004/0117986 A1
(43) Pub. Date: Jun. 24, 2004

(54) Method for the manufacture of a ball valve between two tubes

(76) Inventor: Hannu Eklof, Voiluoto (FI)

Correspondence Address: CLIFFORD G. FRAYNE, Suite 7A, 136 Drum Point Road, Brick, NJ, 08723, US

(21) Appl. No.: 10/716,083

(22) Filed: Nov. 18, 2003

(30) Foreign Application Priority Data
May 23, 2001 (FI) 20011081

(51) Int. Cl. B23P 17/00

(52) U.S. Cl. 29/890.131

(57) ABSTRACT

The invention relates to the method for the manufacture of a ball valve (1) between two tubes (3, 4). In the valve, the valve ball (2) and the ends (7, 8) of the tubes sealed against it are surrounded by the sleeve-like cover (10), which is penetrated by the spindle (13) provided with a handle, the spindle rotating the valve ball for opening and closing the valve. According to the invention, the cover (10) is connected to the mantle surfaces of the tubes (3, 4) by beam welding, such as laser or electron beam welding. For this purpose, the flank of the tube (3, 4) is provided with a front face achieved by a narrowing beveling, and the cover (10) contains a parallel end face brought against it so that the fastening can be performed by directing the welding beam (31) between the faces in their direction. The spindle (13) operating the valve ball (2) is surrounded by the support sleeve (14), which can be attached to the aperture formed to the cover (10) in a similar way using the beam welding technique.

### BACKGROUND OF THE INVENTION

1. Field of the Invention

The object of the invention is a method for the manufacture of a ball valve between two tubes, in which method the ends of the tubes are sealed against a rotatable valve ball opening and closing the valve, and the valve ball and the ends of the tubes are surrounded by a sleeve-like cover to be seamed to the mantle surfaces of the tubes.

2. Description of the Prior Art

Ball valves are available in the markets provided with a full aperture, in which valve type the size of the ports of the valve ball approximately corresponds to the cross-section of the tubes sealed against the ball so that the valve does not substantially narrow the flow path formed by the tubes. In addition to these, ball valves with a reduced aperture are available in the markets, in which valves the ports are smaller than the cross-section of the flow path formed by the tubes. The operating principle of both the valve types is the same; the valve ball can be rotated around the axis perpendicular to the direction of the tubes with the help of a spindle connected to it so that the valve is open as the ports of the ball are turned towards the tubes and closed as the closed flanks of the ball are turned towards the tubes.

The last step in assembling the ball valve is to attach the sleeve-like cover, which is also called the valve body, surrounding the valve ball and the tube ends to the flanks of the tube by welding. The spatters that are generated in the welding can then become a danger to the valve ball fitted to the interior of the cover and to the gaskets for the tube ends against the ball. Upon rotating the valve ball, the attached spatters can damage the gaskets.

The patent specification U.S. Pat. No. 5,890,286 of the applicant discloses the manufacture of a ball valve with a full aperture, in which the tube ends coming against the valve ball are provided with a stepped projection, which forms the gasket housing for the gaskets for the tube ends without narrowing the flow path. As the welding joints attaching the valve body to the tube flanks remain behind the stepwise protruding ends of the tubes, seen from the direction of the valve ball, the projections act as spatter shields, preventing the welding spatters from getting to damage the valve ball and the gaskets. However, despite its advantages, the solution described in the specification does not provide a full protection against spatters. Further, the solution would be very difficult to apply to ball valves with reduced openings, if at all, and the specification does not contain such a description.

The welding technique that is at present most often applied to the assembling of ball valves is the MIG welding performed by using a welding wire and inert shielding gas. In welding, the metal melts at the seam, and the welding wire melts as a part of the generated welding bead. Wire welding is strongly heat-generating, and besides the welding spatters already mentioned, also heating will be a danger to the gaskets for the tube ends. Deformations caused by heat and the irregular quality of the welding seam, in other words, the difficulties to achieve a seam of uniform quality and without root defects, lead to strength problems and to the exposure of the welding seams to corrosion.

Once central application of the ball valve are heating tubes, in which the valves have to endure stresses caused by the large variation of temperature. The regulations by authorities that are becoming more stringent, such as the application of the pressure vessel direction of the EU to valves, is leading to that it is no longer possible to meet the requirements of the most demanding categories with the ball valves manufactured using the state-of-the-art methods.

### OBJECTS OF THE INVENTION

The object of the present invention is to provide a solution, which eliminates the above-mentioned quality problems of the present ball valves and makes possible the manufacture of ball valves meeting the pressure vessel regulations in all respects. In addition, the invention relates to a manufacturing technique, which can be applied to the manufacture of ball valves with both full and reduced apertures. It is characteristic of the method of the invention for the manufacture of a ball valve between tubes that the mantle of the tube has a front face formed by a beveling or stepping, narrowing it towards the end of the tube, that the sleeve-like cover to be sealed to the mantle surfaces of the tube has an end face directed similarly to the front face of the tube, that the front face of the tube and the end face of the cover are brought against each other, and that the tube and the cover are jointed to each other by beam welding by directing the welding beam between said faces brought against each other, following their direction.

Thus, the solution of the invention comprises the machining of the faces of the tube and cover to be jointed to each other so that they will fit tightly to each other, in which case the jointing can be performed by beam welding, such as laser or electron beam welding, which is characterized in that no additional material is brought to the point of jointing for achieving the welding joint. The jointing is exclusively based on the welding beam having a melting effect on the faces to be jointed to each other.

Advantages of the beam welding are that the welding performance is fast and that substantially lower heat has to be brought to the structure to be welded. Thus, a welding joint of uniform quality without root detects is achieved, the strength of which is better and which meets the requirements relating to pressure vessels. As also the risk of spatters is small in beam welding, the welding joints can be brought nearer to the tube ends and the valve ball without causing risks to the gaskets. This again means that the cover surrounding the valve ball and the tube ends becomes even shorter, due to which material is saved and the structure can be made more rigid than before. A modular manufacturing technique can advantageously be used in the manufacture, within which it is possible to achieve a wide product range with simple means of variation.

For the beam welding it is especially advantageous if the tube mantle contains turns or bends on both sides of the front face so that after penetrating the point of jointing formed by the opposite faces, the welding beam hits the material of the tube mantle, to which it stops. The welding beam is then absorbed to the tube mantle, so that the possibility of the spatters to spread along with the beam to the internal space of the cover is fully eliminated. The front face required by the solution can be advantageously provided with a step to be made to the tube mantle beveled or perpendicular in relation to the axial direction.

The alignment of the welding beam is easiest, if the beveled front face of the tube mantle is in an angle of approximately 30-60°, preferably in an angle of 45° in relation to the axial direction of the tube. The laser radiator or some other radiation source can then be kept at a suitable distance from both the tube mantle and the spindle sleeve to be perpendicularly attached to the sleeve-like cover. The welding beam being in the said angles, tubes made of materials of different thickness can be connected to a similar valve cover, and the same welding parameters can thus be used for different tubes.

According to the invention, also the said spindle with the surrounding sleeve rotating the valve ball can be installed in the valve using beam welding for the jointing of the sleeve. An aperture has to be formed to the sleeve-like cover of the valve for the spindle and the sleeve surrounding it so that the edge of the aperture can be formed so that it is located in one plane parallel to the axis of the tubes. As the spindle with the surrounding sleeve is fitted into the aperture, the welding joint can be made in one plane in the beam welding in a way required by the quality requirements for beam welding. Also the mating faces of the edge of the aperture and the spindle sleeve to be jointed together can be in an angle of 30-60°, preferably in an angle of 45° in relation to the axial direction of the tubes so that neither the spindle sleeve nor the tubes form an obstacle for the welding. If the said mating faces and the above-mentioned front face of the tube mantle are in the same angle in relation to the axial direction of the tubes, it is possible to perform the jointing of the cover to the tube mantle and the jointing of the sleeve surrounding the spindle to the cover successively without it being necessary to change the alignment of the source of the welding beam.

In addition to the method for the manufacture of the ball valve disclosed above, the present invention comprises the use of beam welding, such as laser or electron beam welding for assembling the ball valve, for fastening the sleeve-like cover surrounding the valve ball and the tube ends sealed against it from its ends to the tube flanks and/or for fastening the support sleeve of the spindle rotating the valve ball to the aperture made to the said sleeve-like cover.

### SUMMARY OF THE INVENTION

The invention relates to the method for the manufacture of a ball valve between two tubes. In the valve, the valve ball and the ends of the tubes sealed against it are surrounded by the sleeve-like cover, which is penetrated by the spindle provided with a handle, the spindle rotating the valve ball for opening and closing the valve. According to the invention, the cover is connected to the mantle surfaces of the tubes by beam welding, such as laser or electron beam welding. For this purpose, the flank of the tube is provided with a front face achieved by a narrowing beveling, and the cover contains a parallel end face brought against it so that the fastening can be performed by directing the welding beam between the faces in their direction. The spindle operating the valve ball is surrounded by the support sleeve, which can be attached to the aperture formed to the cover in a similar way using the beam welding technique.

### BRIEF DESCRIPTION OF THE DRAWINGS

The invention is next described in more detail with the help of examples, referring to the enclosed drawings, in which:

FIG. 1 is a longitudinal section of the cover blank;

FIG. 2 is the cross-section II-II of the cover blank in FIG. 1;

FIG. 3 shows the forming of the cover blank to the sleeve-like cover of the ball valve with reciprocating moulding tools compressing the blank;

FIG. 4 shows the sleeve-like cover of the ball valve formed by compression and the valve ball in longitudinal section;

FIG. 5 is the cross-section V-V of the cover and valve ball in FIG. 4;

FIG. 6 shows the cover of the ball valve with its valve ball, the tubes to be connected to the valve ball, and the spindle rotating the valve ball with its support sleeves and handles before joining the said parts together;

FIG. 7 shows the parts in FIG. 6 assembled as a ball valve, which is jointed by welding and provided with a reduced aperture, the Figure also depicting the sources of radiation and the welding beams directed from them to the welding joints;

FIG. 8 shows a second embodiment of the ball valve with a full aperture, jointed by beam welding;

FIG. 9 shows the cover and the tube mantle welded to it, the material thickness of which is substantially the same, in enlarged scale; and

FIG. 10 is similar to FIG. 9, showing an embodiment, in which the material thickness of the cover is larger than that of the tube mantle.

### DETAILED DESCRIPTION OF THE INVENTION

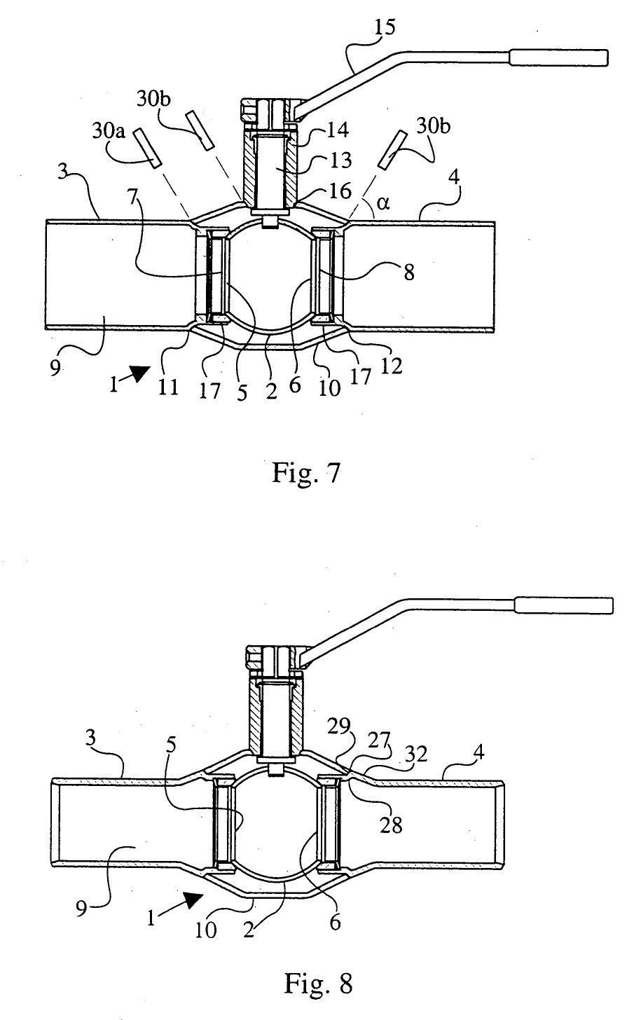

The ready-assembled ball valve 1 with a reduced aperture shown in FIG. 7 is described first. The ball valve 1 comprises the valve ball 2, which works as the joint body between two tubes 3, 4 with round cross-section, connected to the valve. The valve ball 2 is hollow, and it comprises ports 5, 6, which are slightly reduced in relation to the tubes and which in the Figure are turned towards the tube ends 7, 8 so that the flow channel 9 formed by the tubes 3, 4 is open. The element that keeps the ball valve 1 together consists of the sleeve-like cover 10 tapered from both ends by compression, i.e. the so-called valve body, the ends of which are attached to the flanks of the tubes 3, 4 with the welding joints 11, 12. For opening and closing the ball valve 1, the spindle 13 is fastened to the valve ball 2, the spindle being surrounded by the support sleeve 14 and provided with the handle 15. The support sleeve 14 is fitted to the aperture made for it in the cover 10 and attached to it by the welding joint 16. Closing the valve is performed by rotating the spindle 13 and the valve ball 2 rotating with it 90° from the position in the Figure, using the handle 15 so that the closed flanks of the valve ball rotate against the ends 7, 8 of the tubes 3, 4. The ends 7, 8 of the tubes are provided with the gaskets 17 against the ball valve 2 for preventing leakage.

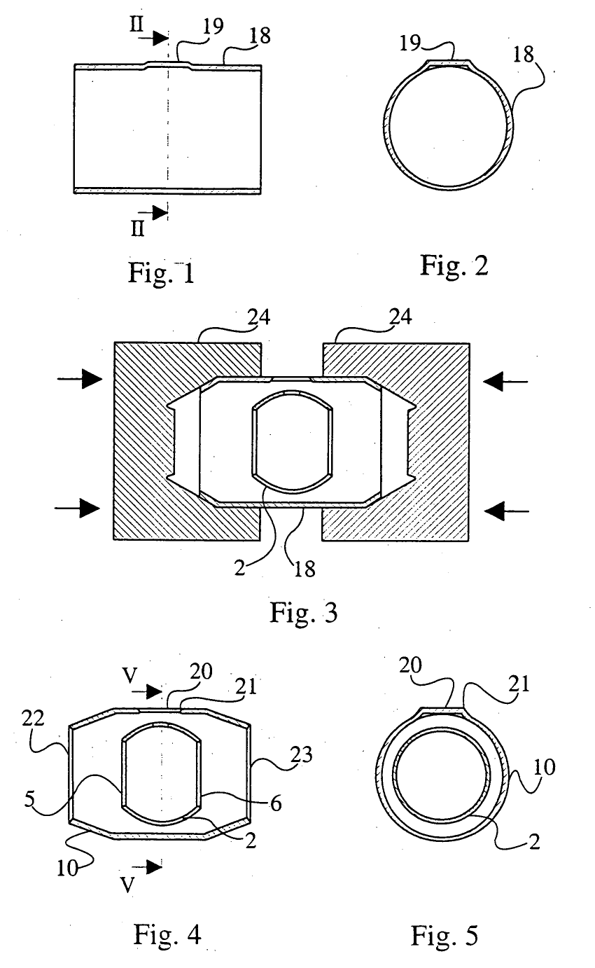

The steps according to the invention for the manufacture and assembly of the ball valve 1 with a reduced aperture appear from the FIGS. 1-7 in the drawings. The starting point is the cover blank 18 according to FIGS. 1 and 2, formed of the tube piece, the round seat 19 in the plane parallel to the longitudinal axis of the piece being machined to the cover blank for the subsequent fastening of the spindle 13 and its support sleeve 14. For the support sleeve 14 of the spindle, the aperture 20 is pierced at the place of the seat 19; the aperture can be seen in FIGS. 3-6 in the sleeve-like cover 10 of the valve, machined from the blank 18. The machining also comprises the beveling of the edge 21 of the aperture 20 and the ends 22, 23 of the generated cover 10 for the subsequent jointing by beam welding. The conically beveled end faces 22, 23 of the cover form an angle of 45° in relation to the axial direction of the tubes 3, 4.

The forming of the cover blank 18 according to FIGS. 1 and 2 to the sleeve-like cover 10 tapering conically towards its ends 22, 23 by compressing is performed by reciprocally moving moulding tools 24, according to FIG. 3. The tools 24 are forced towards each other according to the arrows in FIG. 3 until they bump into each other, after which the tools perform the return movement. Before compression the valve ball 2 has been brought to the interior of the cover blank 18, support to appropriate termporary support elements (not shown). The valve cover 10 machined to its finished form as the result of compression is shown in FIGS. 4 and 5.

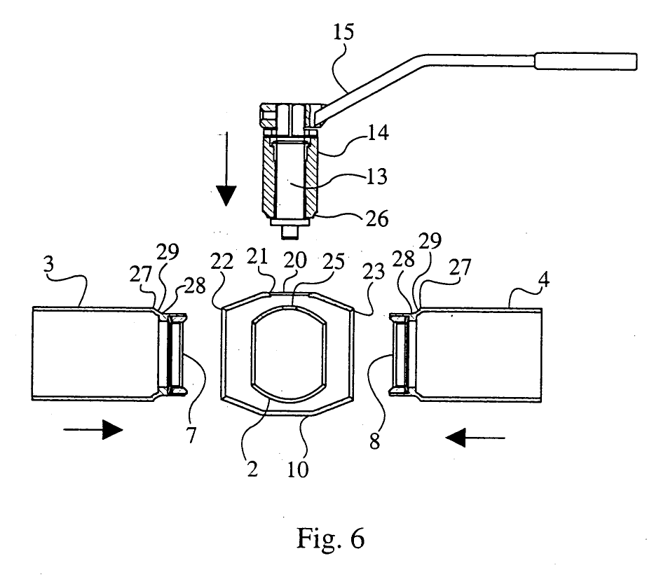

FIG. 6 is a schematic presentation of the parts of the ball valve during the jointing step. The end of the spindle 13 is attached to the hole 25 provided for it in the valve ball 2 so that the end face 26 of the support sleeve 14 of the spindle, beveled similarly to the edge 21 of the aperture of the cover, is set to lean against the said edge. From the ends 22, 23 of the cover, the tubes 3, 4 are brought to the interior of the cover so that the ends 7, 8 of the tubes are sealed against the valve ball 2. The flanks of both the tubes 3, 4 have the front face 29 rotating conically around the tube and being restricted by the folds 27, 28, the front face being machined in the angle of 450 in relation to the axial direction of the tube, similar to the end faces 22, 23 of the cover. As the tubes 3, 4 have been brought to place, the front faces 29 are set tightly against the end faces 22, 23 of the cover to be jointed by beam welding the tubes and the cover.

The said bringing together of the valve parts brings them to a position in relation to each other, in which they are in the finished ball valve 1 according to FIG. 7. The jointing together of the parts is performed by beam welding, and FIG. 7 shows the source of radiation 30 and the welding beam 31, for example, laser beam generated by it in three different positions 30a-30c required by the welding of the joints 11, 12, 16. The inlet angle β of the welding beam 31 marked to the Figure is equal to the angle of 45° of the surfaces to be welded in relation to the axial direction of the tubes. The welds can be performed either by rotating the source of raditation 30 in relation to the strationary valve or keeping the source of radiation stationary and rotating the valve. It can be seen from FIG. 7 that in the welding of the front faces 3, 4 of the tubes and the ends of the cover 10 in the welding beam 13 penetrating the joint 11, 12 meets the material of the tube mantle, to which the travel of the beam stops.

FIG. 8 shows the finished beam-welded ball valve 1 with full aperture, which differs from the one shown in FIG. 7 in that the ports 5, 6 of the valve ball 2 generally correspond to the cross-sectional area of the tubes 3, 4 so that, because of this, the flow channel 9 formed by the tubes penetrates the valve without choking. In both the tubes 3, 4 the mating comprises the expansion 32, which is conical seen from the direction of the tube and for which the cover 10 tapering towards its ends forms a direct continuation. The expansion 32 is followed by successive turns 27, 28, restricting between them the front face 29, which conically reduces the tube mantle, the end of the cover being attached to the front face by beam welding as in the form of embodiment described above, cf. FIGS. 6 and 7.

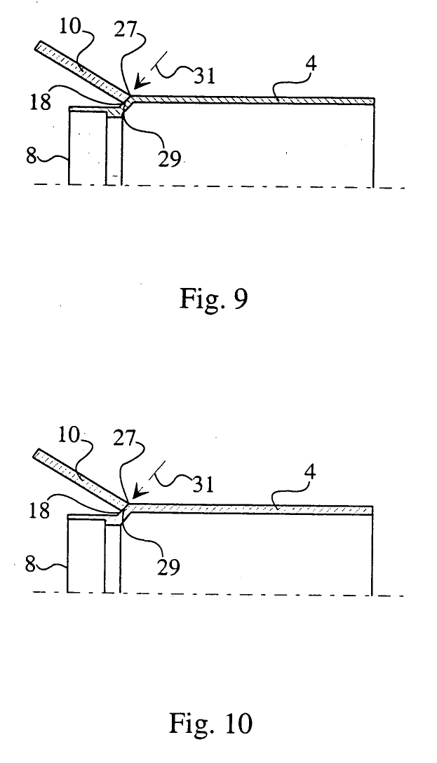

FIGS. 9 and 10 are intended to illustrate the possibility offered by the invention to use cover parts 10 with similar material thickness in connection with tubes 4 with different material thickness. In FIG. 9, the material thickness of the cover 10 and the mantle of the tube 4 is essentially the same, when again in FIG. 10, the cover 10, which is the same as in FIG. 9, has a bigger material thickness than the mantle of the tube 4. The front face 29 restricted by the turns 27, 28 has similar dimensions in each case, and the beam welding by the welding beam 31 directed according to the surface can in both cases be performed using the same welding parameters.

It is obvious for one skilled in the art that the embodiments of the invention are not restricted to the examples described in detail above, but they may vary within the scope of the following claims.

1. (Currently amended) Method for the manufacture of a ball valve (1) between two tubes (3,4), in which method the ends (7, 8) of the said tubes are sealed against rotatable valve balls (2) opening and closing the said valve, and the said valve ball and the said tube ends are surrounded by a sleeve-like cover (10) to be jointed to the mantle surfaces of the said tubes, characterized in that the said mantle of the said tube (3, 4) has a front face (29) formed by a beveling or stepping, narrowing it towards the said ends (7, 8) of the said tube, that the said sleeve-like cover (10) has an end face (22, 23) directed similarly to the said front face of the said tube, that the said front face of the said tube and the end face of the said cover are brought against each other, and that the said tube and said cover are jointed to each other by beam welding by directing the a welding beam (31) between said faces brought against each other, following their direction.

2. (Currently amended) Method according to claim 1, characterized in that the said mantle of the said tube (3, 4) has turns (27, 28) on both sides of the said front face (29) so that the said welding beam penetrating the a joint (11, 12) formed by the opposite surfaces hits the turn and the material of the said tube mantle below.

3. (Currently amended) Method according to claim 1 or 2, characterized in that the said beveled front face (29) of the said mantle of the said tube (3, 4) is in an angle of approximately 30-60°, preferably approximately 45° in relation to the axial direction of the said tube.

4. (Currently amended) Method according to one of the preceding claims, claim 1 or 2 characterized in that it is used for the manufacture of a said ball valve with a reduced aperture (5, 6).

5. (Currently amended) Method according to one of the claims 1-3, claim 1 or 2 characterized in that it is used for the manufacture of a said ball valve with a full aperture so that the said mantle of the said tube (3, 4) has been expanded (32) and then narrowed for achieving the said beveled front face (29) for jointing the said sleeve-like cover (10).

6. (Currently amended) Method according to one of the preceding claims, claim 5 characterized in that the said cover (10) is attached to the said mantle of the said tube (3, 4) by laser welding (30, 31).

7. (Currently amended) Method according to one of the claims 1-5, claim 5 characterized in that the said cover (10) is attached to the said mantle of the said tube (3, 4) by electron beam welding.

8. (Currently amended) Method according to one of the preceding claim, claims 1 or 2 characterized in that an aperture (20) is provided to the said cover (10), to which aperture the a spindle (13) rotating the said valve ball (2) and the a surrounding support sleeve (14) are fitted, the vale ball (2) and the said surrounding support sleeve (11) are fitted, the said support sleeve being jointed to the an edge (21) of the said aperture by beam welding.

9. (Currently amended) Method according to claim 8, characterized in that the said cover (10) is shaped so that the an edge (21) of the said aperture (20) is located in one plane parallel to the axis of the said tubes (3, 4).

10. (Currently amended) Method according to claim 9, characterized in that the mating faces (21, 26) of the said edge (21) of the said aperture (20) and the said support sleeve (14) of the said spindle, which are jointed together by beam welding, are in an angle of 30-60°, preferably approximately 45° in relation to the axial direction of the said tubes (3, 4).

11. (Currently amended) The use of beam welding, such as laser or electron beam welding in the assembly of a ball valve (1) when attaching the a sleeve-like cover (10) surrounding the a valve ball (2) and the said ends (7, 8) of the said tubes (3, 4) sealed against it from it said ends (22, 23) to the said flanks of the tubes.

12. (Currently amended) The use of beam welding, such as laser or electron beam welding in the assembly of a ball valve when attaching the a support sleeve (14) of the a spindle rotating the a valve ball (2) to the an aperture (20) made to the a sleeve-like cover (10) surrounding the said valve ball and the having ends (7, 8) of the said tubes (3, 4) sealed against it.
